(19) United States
(12) Patent Application Publication
(10) Pub. No.: US 2003/0235805 A1
(43) Pub. Date: Dec. 25, 2003

(54) Dental post with countersink

(76) Inventor: Steven Lax, New York, NY (US)

Correspondence Address: NOTARO AND MICHALOS, 100 DUTCH HILL ROAD, SUITE 110, ORANGEBURG, NY, 10962-2100, US

(21) Appl. No.: 10/443,579

(22) Filed: May 22, 2003

Related U.S. Application Data
(63) Continuation-in-part of application No. 10/151,765, filed on May 21, 2002.

(51) Int. Cl. A61C 5/08

(52) U.S. Cl. 433/220

(57) ABSTRACT

A dental post for supporting a tooth replacement on a natural tooth root has a shank with a first root engagement portion and a second tooth replacement support portion. A non-round countersink structure is on the first portion but is adjacent the second portion. The structure is received in a countersink at the opening of the root canal for helping precluding relative rotation between the post and the root. One or more flexible flanges extend from one or both of the shank portions and the entire post may be made of plastic.

### CROSS-REFERENCE TO RELATED APPLICATION

This is a continuation-in-part of application Ser. No. 10/151,765 filed May 21, 2002, which is incorporated here by reference.

### FIELD AND BACKGROUND OF THE INVENTION

The present invention relates generally to the field of dentistry and, in particular, to further improvements in the dental post disclosed in application Ser. No. 10/151,765.

A wide variety of posts are known for use in supporting tooth replacements such as crowns, bridges or other structures above a patients gum line. The posts are usually made of strong metal and have shanks that extend in, and are cemented to hollow root canals prepared by the dentist by drilling out the dead root and other tissue from a damaged tooth.

Although usually made entirely rigid, a flexible post is disclosed by U.S. Pat. No. 5,919,044 to Sicurelli, Jr. et al. This flexible post is made from fiberglass or optical fibers suitable for medical use. U.S. Pat. No. 6,135,775 to Weisman also discloses a post made of plastic.

A dental post with a tapered, polygonal cross-section is disclosed in U.S. Pat. No. 347,975 to Starr. U.S. Pat. No. 403,428 to Hansen discloses an artificial tooth plug having a conical shank with threads for inserting into a tooth root and a larger diameter collar around the base. The collar provides protection over the root but does not extend into the root.

U.S. Pat. No. 616,302 to Evans discloses a post and disk for attaching crowns. The post is secured inside the root socket and the disk, which has a larger diameter than the post, prevents downward movement and supports an artificial tooth externally. U.S. Pat. No. 984,782 to Starr teaches a crown pin having a generally cylindrical lower portion with a flattened side and a perpendicular plate at one end that also extends over a tooth root. Also see U.S. Pat. Nos. 1,109,080 and 1,479,508, for other dental post structures.

A dental post having a polygonal perimeter for the crown but not for the tooth root, is disclosed in U.S. Pat. No. 1,589,994 to Simmons. U.S. Pat. No. 3,508,334 to Weissman disclosed a guide post with flange and drill guides but is not meant to be a permanent part of the patients dental work. U.S. Pat. No. 4,427,383 to Goldman teaches a tooth reconstruction having a threaded screw and a hex nut which is inside and supports an artificial tooth. U.S. Pat. No. 4,449,937 to Weissman shows a dental anchor having a threaded implant portion, a flange and a square anchoring portion secured to the opposite side of the flange. The flange is intended to prevent further movement into a tooth root canal, while the anchoring portion prevents rotation of a dental prosthesis connected using the anchor. These parts of the post are in the crown and not the tooth root.

Also see U.S. Pat. Nos. 4,543,065 and 4,588,381. U.S. Pat. No. 4,600,391 to Jacob teaches a cylindrical countersink flange for being seated in a cylindrical countersink at the top of a tooth root canal. This structure does not and cannot not resist rotation of the post in the root since rotation is, in fact, necessary to install this threaded post. A cylindrical, and therefore rotatable, countersink is also taught by U.S. Pat. No. 5,348,476 to Cohen et al.

See U.S. Pat. No. 4,759,714 to Szegvary which discloses a post with threaded shank post that is fixed into the root with the ususal composite cement, and an upper crown supporting portion with rigid side ribs for extending into the luting cement inside a crown. Other posts with threads of other structures to help secure the post shank are disclosed in U.S. Pat. Nos. 4,778,388; 4,846,685; 5,066,230 and 5,326,263.

A need remains for an improved post which will not rotate in the root and which securely supports a tooth replacement.

### SUMMARY OF THE INVENTION

It is an object of the present invention to provide a dental post for supporting a tooth replacement on a natural tooth root having a hollow canal from which a nerve has been removed, the canal having a countersink opening at the top of the tooth root communicating with the canal opening, the post having a shank with a first root engagement portion for extending into the hollow canal, and a second tooth replacement support portion for extending out of the canal. The post has a non-round countersink structure formed on the first portion but adjacent the second portion, the non-round countersink structure being received in the countersink.

Another object of the invention is to provide a dental post including at least one flexible flange formed as one piece with or as one or more separate pieces from the shank and extending outwardly from either the first or the second portions of the shank, or both. According to another object of the invention, two to three flexible flanges extend outwardly from the first root engagement portion in the root and two to three such flanges also extend outwardly from the second, tooth replacement receiving or support portion of the shank.

A still further object of the invention is to manufacture the post entirely of a suitably strong and biocompatible plastic that is capable of being cemented to the root and to which a crown or other tooth replacement can be cemented.

Another object of the invention is to form the second portion of the post to be non-round, in particular, polygonal to further increase adhesion to and anti-rotation of the tooth replacement to be bonded to the post.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side elevational view that is partly ib section of a tooth root with root canal and countersink opening and containing a dental post of the present invention;

FIG. 2 is a side elevational and exploded view of another embodiment of the post of the present invention;

FIG. 3 is a perspective view of a flexible flange lattice according to another embodiment of the invention;

FIG. 4 is a top plan view of a tooth root with the post of the invention installed but without the flange structure illustrated;

FIG. 5 is a view similar to FIG. 4 of another embodiment of the invention;

FIG. 6 is a perspective view of a dental post of the present invention for the tooth root of FIG. 5; and

FIG. 7 is a perspective view of a still further embodiment of the invention with a differently shaped tooth replacement support portion.

### DESCRIPTION OF THE PREFERRED EMBODIMENTS

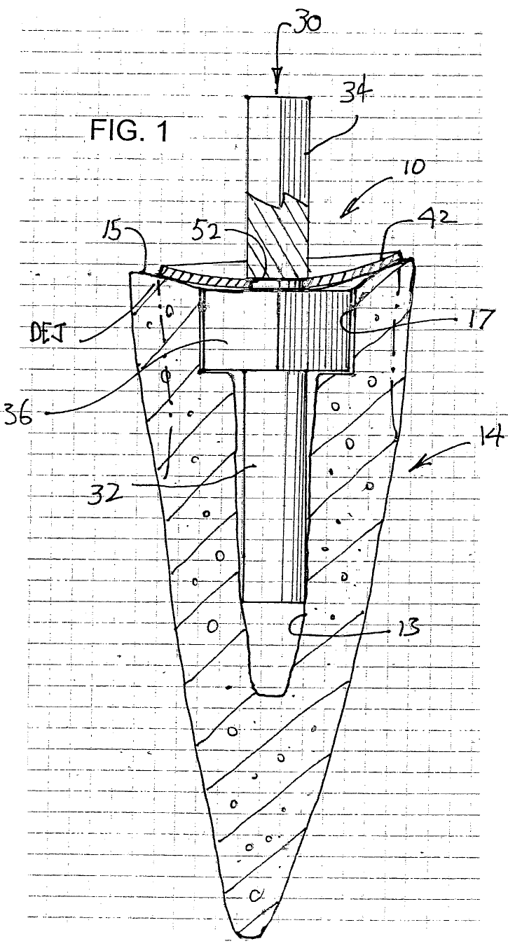

Referring now to the drawings, in which like reference numerals are used to refer to the same or functionally similar parts, FIG. 1 illustrates a dental post of the present invention, generally designated 10, for supporting a tooth replacement such as a crown or bridge hardware (not shown), on natural tooth root 14.

The mounting a tooth replacement to the natural tooth root 14, starts with the drilling a hollow canal 13 in the tooth root 14, to remove the nerve and surrounding tissue in a usual manner using a dental drill or burr. The canal is then countersunk to form an outer countersink opening 17, again using a know drill and technique. According to one technique of the invention, the countersink 17 can be further shaped using a small burr to cut out excess material around the opening, or an ultrasonically powered cutting tool shaped like the countersink structure 12 to be describer later in this disclosure.

The post 10 has a non-round, e.g. hexagonal, countersink structure 36, formed as one piece with or as a separate piece attached to a shank 30 that extended like a backbone at the axial center of the post. Structure 36 is on a first, root engagement portion 32 of the shank, at the top of this first portion, but adjacent a second tooth replacement supporting portion 34 at the top of the shank in FIG. 1. For a lower tooth, the arrangement of FIG. 1 is inverted.

In the embodiment shown the non-round flange 36 is hexagonal to match and closely sit in the hexagonal countersink opening 17. Any non-round shape can be used, however, such as any other type of polygon e.g. having four sides (FIG. 7) or three to twelve or even more sides, or even an oval or key shaped structure (FIG. 7) or irregular, non-round shape. The purpose of the countersink structure 36 when it is seated in the corresponding countersink opening 17, according to the invention, is to prevent the post 10 from rotating in the root canal.

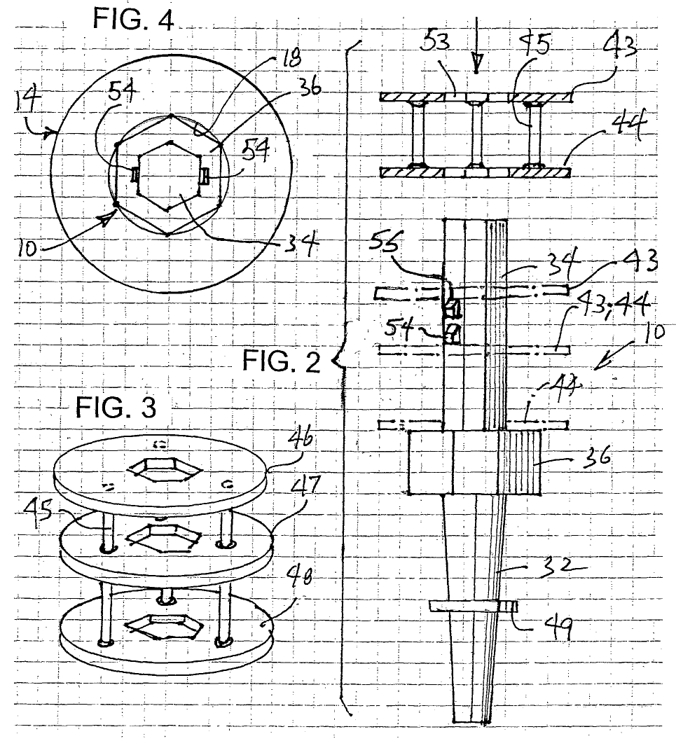

Turning to FIG. 4, the countersink opening 18 may be cylindrical and made with a large diameter burr or opened with a small diameter burr that is moved in an orbital manner. The diameter of opening 18 is made to be substantially the same as the largest radial dimension of countersink structure 36 so that the polygonal structure 36 touches the opening 18 only at its corners. Even is the corners do not touch since the voids between the structure 36 and the opening 18 will be filled with bonding material, the post of the invention will still resist rotation of the post 10 in the tooth root 14.

The dental post of the invention, as shown, for example, in FIGS. 1, 2 and 3, also include at least one flexible flange 42 (FIG. 1), or two flanges 43 and 44 (FIG. 2, or three flanges 46, 47 and 48 (FIG. 3, formed as one piece with the shank 30 or as separate pieces that are attached to the shank 30. The flanges extend outwardly from the second portion 34 of the shank. Similar flanges can be used on the first shank portion 32 as well.

The shank, non-round countersink structure and flexible flanges are advantageously make of reinforced of non-reinforced plastic of suitable composition that is cast or injection molded as one piece or multiple pieces. The parts of the post may alternatively be made of suitable surgical grade metal.

In one preferred embodiment of the invention both the first, root engaging portion 32 and the second, tooth replacement support portion 34 have from one to three flexible flanges. FIG. 2 illustrates a flange 49 on first portion 32. In FIG. 6, however, neither portion has a flange.

Any known, biocompatible, strong yet flexible plastic or polymer, that is also compatible with the types of cements that would be needed to secure the post to the root and to secure the crown or other tooth replacement to the post, can be used to make the dental post of the present invention.

Examples include: polyamide (PA or Nylon), a thermoplastic polycondensate used to make parts of moderate strength; melamine formaldehyde (MF), thermoset polycondensate used in molding items with high surface hardness and scratch resistance; polyvinylchloride (PVC), thermoplastic polymer used for medical applications in rigid grades; polyethylene (PE), thermoplastic polymer with good toughness polyurethane (PU), thermoplastic or thermoset with high impact resistance and chemical and abrasion resistance; polyester, thermoplastic or thermoset polycondensate with excellent dimensional stability and good toughness; polypropylene (PP), a thermoplastic polymer used to make medical syringes with high resistance to flexing but excellent for living hinges, good strength and chemical resistance, good impact strength, and high solvent resistance; polyimide (PI), thermoplastic or thermoset polycondensate with high impact heat resistance and low coefficient of thermal expansion; polyacetal (acetal); polycarbonate (PC), thermoplastic polycondensate used to make optical lenses and medical items with excellent strength and toughness, good dimensional stability and impact resistance; acrylonitrile-butadiene-Styrene (ABS), thermoplastic used in consumer products and being tough, hard and rigid with good chemical resistance and dimensional stability; polyetheretherketone (PEEK), thermoplastic polycondensate with high tensile and flexural strength, high impact strength, and a high fatigue limit; or ionomer, a thermoplastic polymer with tough and scratch-resistant qualities.

The skilled artisan can select other plastic materials as well.

The first portion 32 is either cylindrical or tapered, and the second portion 34 is cylindrical or polygonal. When polygonal as in FIG. 1 (hex) or FIG. 7, (square) the corners may be rounded for better adhesion to the bonding material for holding the post to the tooth replacement.

The ends of the shank may be rounded or flat and outer surfaces of all or parts of the post are textured, roughened or provided with regular grooves and/or ridges to help positively connect the post to the bonding material or cement.

The flexible flange or flanges on the root portion 32 are designed to flex upwardly to wedge against the inner surface of root canal 13 and help better fix the post in place. The flange of flanges on the tooth replacement support portion 34 help better fix the post to the cast cement and ultimately to the crown or other tooth replacement hardware.

Referring once more to FIG. 1, the flexible flange 42 is made as a separate washer shaped structure which has a central circular hole 52 that is captured within an annular groove around the second shank portion 34 immediately above the countersink structure 36. Since the hole 52 is slightly smaller than the maximum radial dimension of the hexagonal second portion 34, and further flange 42 is made of flexible material, it can be forced down onto second shank portion 34 and pushed down toward structure 36 until hole 52 snaps into the annular groove. This positively holds the flange 42 to the rest of the post. As shown in FIG. 1, the top surface 15 of the tooth root 14 is not always perfectly flat but sometimes descends down toward the countersink opening 17. When this occurs, flexible flange 42 is bent upwardly but firmly pressed down against the top surface of root 14 and bonded to that surface by the cement used to bond the tooth replacement to the shank portion 34. The upward deflection of flexible flange 42 also helps laterally and axially stabilize the post 10 in the root 14 but does not exert such force as to extract the first shank portion 32 from the root canal 13. Flanges on the second shank portion 32, for example flange 49 in FIG. 2, helps further fix the first lower shank portion 32 in the root canal in the other embodiments of the invention.

FIG. 2 illustrates an embodiment where the flanges 42 are 44 are connected to each other by three equally spaced pins or shafts which can be cast as one piece with the flanges or adhered, for example fused or glued to the flanges to hold them at a fixed location from each other. A central hexagonal hole 53 extends through each of the flanges and has substantially the same shape and dimensions as the second shank portion 34. Resilient stops 54 are molded onto the outer surface of two sides of the hexed shaped portion 34 and have a beveled upper surface and radially extending lower surface. In this way, the flanges can be pushed past the stops 54, until both are below the stop. The radial lower surface of stops 54 prevents upward movement of the flange lattice formed by the flanges 43 and 44 and the pins 45. The phantom position of the flanges in FIG. 2 shows their final location on the post.

As also shown in FIG. 2, a second pair of stops 55 can be provided above the first pair of stops 54. This can establish one or more raised positions for the flanges 43, 44. One of the raised positions is illustrated in FIG. 2 where the stops 54, 55 are between the flanges 43, 44 and preclude either downward or upward movement of the flanges. A further lowered position with flange 43 between the stops 54 and 55 can also be established if it is desired to have the lower flange 44 closer to the countersink structure 36.

Also within the scope of the present invention, it is contemplated that multiple posts 10 can be provided in different lengths and sizes with different separate flanges or flange lattices for attachment to the shank. In this way, different sizes of teeth with different numbers or roots can be treated with a single kit containing multiple posts and multiple flange configurations.

FIG. 3 shows a further embodiment of the invention where three flanges are connected by pins or posts 45.

The use of flange lattices with a plurality of flanges helps further integrate the cement into and between the post parts and the tooth replacement parts to positively prevent rotation between the tooth replacement and the post while firmly fixing the tooth replacement to the post.

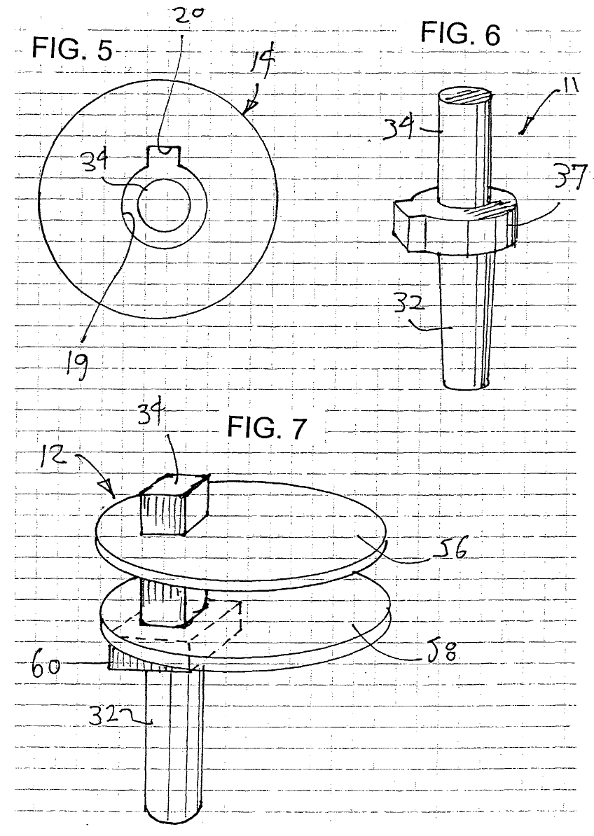

FIG. 5 illustrates another embodiment of the invention where root 14 contains an initially circular countersink opening 19. In this embodiment a burr, for example a 556 burr can be used to cut out a key hole projection 20 from the countersink opening 19. FIG. 16 shows a comparably shaped 20 from the countersink opening 19. FIG. 16 shows a comparably shaped countersink structure 37 which fits into the countersink structure 19, 20 to prevent rotation between the root 14 and the post which in FIG. 6 is generally designated 11.

FIG. 7 illustrates a post which has a cylindrical first shank portion 32 and a square seconded shank portion 34 which carries a pair of offset flexible flanges 56 and 58. A square countersink structure 60 is also provided for post 12. Post 12 is particular suited for use on double or triple root teeth where the flange is 56, 58 have portions that extend out over the upper surface of the remainder of the tooth, lower flange 58 being bonded to and bearing against this upper surface of lateral and axial stability of the post in the tooth.

Although the countersink structures 36 or 37 are important parts of the invention, the flexible flange or flanges on or both of the first lower or second upper shank portions 32 or 34 can be used without the countersink structures.

The flange or flanges can also be oval or have other shaped to more closely match the shape of the tooth root top surface which is usually oval. The flanges advantageously extend radially outwardly from the second tooth replacement portion 34, substantially to the dentin enamel junction shown ad DEJ in FIG. 1. This helps better support the cement or bonding material that holds the crown or other tooth replacement to the shank portion 34.

While specific embodiments of the invention have been shown and described in detail to illustrate the application of the principles of the invention, it will be understood that the invention may be embodied otherwise without departing from such principles.

What is claimed is:

1. A dental post for supporting a tooth replacement on a natural tooth root, the tooth root having a hollow canal from which a nerve has been removed, the canal having an outer opening and a countersink opening at the top of the tooth root communicating with the canal outer opening, the post comprising:
a shank having a first root engagement portion for extending into the hollow canal, and a second tooth replacement support portion for extending out of the canal and adapted to support a tooth replacement; and
a non-round countersink structure on the first portion but adjacent the second portion, the non-round countersink structure being adapted to be received in the countersink opening for helping to precluding relative rotation between the post and the root.

2. A dental post according to claim 1, including at least one flexible flange extending outwardly from one of the first and second portions of the shank.

3. A dental post according to claim 2, wherein the at least one flexible flange extends outwardly from the first root engagement portion.

4. A dental post according to claim 2, wherein the at least one flexible flange extends outwardly from the second tooth replacement portion.

5. A dental post according to claim 4, wherein the flexible flange is made of a separate piece of material from the second tooth replacement portion, the post including means for connecting the flexible flange to the second tooth replacement portion.

6. A dental post according to claim 5, including a plurality of said flexible flanges connected to and spaced from each other.

7. A dental post according to claim 1, wherein the second portion of the shank is non-round.

8. A dental post according to claim 7, wherein the non-round countersink structure and the non-round second tooth replacement portion are each a polygonal.

9. A dental post according to claim 4, wherein the at least one flexible flange is connected to the second tooth replacement portion at a location adjacent the non-round countersink structure to engages onto at least part of a top surface of the tooth root around the canal outer opening to help bond the post to the root and to laterally and axially stabilize the post on the tooth root.

10. A dental post according to claim 5, wherein each flexible flange has an opening therethrough through which the second portion of the shank extends, means for connecting the flexible flange to the second portion comprises a plurality of stops on the second portion for engaging and fixing a relative position of the flange to the second portion of the shank.

11. A dental post according to claim 10, wherein the opening through the flange and the second portion of the shank are polygonal in shape.

12. A dental post according to claim 11, including a plurality of flanges connected to each other and engaged to the second portion of the shank.

13. A dental post according to claim 5, including means for connecting the flexible flange to the second tooth replacement portion comprises a hole through the flexible flange and an annular groove around the second portion of the shank for receiving the flange hole.

14. A dental post according to claim 5, wherein the means for connecting the flexible flange to the second tooth replacement portion is positioned to fix the flexible flange closely adjacent the non-round countersink structure.

15. A dental post according to claim 1, wherein the non-round countersink structure is in the form of a key for being received in a key hole shaped countersink opening.

16. A dental post for supporting a tooth replacement on a natural tooth root, the tooth root having a hollow canal from which a nerve has been removed, the canal having an outer opening and a countersink opening at the top of the tooth root communicating with the canal outer opening, the top of the root having a dentin enamel junction, the post comprising:
a shank having a first root engagement portion for extending into the hollow canal, and a second tooth replacement support portion for extending out of the canal and adapted to support a tooth replacement; and
at least one flexible flange extending outwardly from one of the first and second portions of the shank.

17. A dental post according to claim 16, wherein the at least one flexible flange extends outwardly from the first root engagement portion.

18. A dental post according to claim 16, wherein the at least one flexible flange extends outwardly from the second tooth replacement portion and extends substantially to the dentin enamel junction.
